(19) United States
(12) Patent Application Publication
(10) Pub. No.: US 2008/0131020 A1
(43) Pub. Date: Jun. 5, 2008

(54) Method for enhancing three-dimensionality of electronic images and device of the same

(76) Inventor: Ying-Ching Hou, Taipei City (TW)

Correspondence Address: YING-CHING HOU, 235 Chung-Ho, Box 8-24, Taipei, omitted

(21) Appl. No.: 11/633,227

(22) Filed: Dec. 5, 2006

(51) Int. Cl. G06K 9/40

(52) U.S. Cl. 382/260

(57) ABSTRACT

A method for enhancing three-dimensionality of electronic images and a device of the same comprises a multi-channel signal filtering module for receiving input video signals and then decomposing each of the images into a multitude of single-mode signals, a signal analyzing unit coupled with the multi-channel signal filtering module for analyzing the single-mode signals and for determining a frequency distribution spectrum, a frequency-distribution adjustment/signal amplifying unit coupled with the signal analyzing unit for redistributing relative amplitudes of signals of various frequencies in accordance with a predetermined transformation model, and a signal mixing unit coupled with the frequency-distribution adjustment/signal amplifying unit for combining the readjusted single-mode signals to form output video signals.

### FIELD OF THE INVENTION

The present invention relates to methods for enhancing three-dimensionality of electronic images, more particularly to a method for enhancing three-dimensionality of electronic images and a device of the same that utilize multiple filtering circuitry and signal amplifying circuitry to adjusting the depth of field of the images dynamically by changing the frequency of the input signals.

### BACKGROUND OF THE INVENTION

The hardware components associated with flat displays, such as LCD panels, back light modules and driving circuits, have attained maturity. Thereby, the quality of images has much improved.

One factor that influences the quality of images on a flat display is brightness (in units of cd/m²). There are two ways to enhance the brightness of an LCD panel: (1) increasing the light transmission; and (2) increasing the brightness of the background lights. However, products with brighter images may make viewers uncomfortable and induce fatigue. At the same time, the contrast between pure black and pure white may be sacrificed, further influencing color depth and gray scale.

There are other factors affecting the image quality, which are contrast and sharpness. Common LCD displays have adjusting mechanisms for changing brightness, contrast and sharpness. Such adjustments are processed by a pre-amplifier in an LCD monitor. Or there are a set of built-in parameters for these factors for a user to choose.

“A method for adjusting sharpness and brightness of digital image” disclosed by R.O.C. patent number I241534 utilizes a function input into a processor, whereby the sharpness and the brightness of digital image can be adjusted simultaneously. Further, a sharpness control parameter is input to adjust the sharpness and the brightness of digital image simultaneously. The output video signal is therefore processed in one step, saving memory and simplifying circuit design.

It is notable that the computational algorithm for improving the image sharpness and brightness can enhance the contrast between darkness and brightness, thereby making images clearer, it cannot enhance the three-dimensionality of the images. It is because there exist no adjustment parameter for image three-dimensionality.

### SUMMARY OF THE INVENTION

The primary objective of the present invention is to provide a method of adaptive transient improvement for depth of field, so as to enhance the clearness of outlines in the images by changing the frequency of the associated image portions. Thereby, the objects in the images will appear more three-dimensional.

The technique of the present invention is decomposing the input signals into a multitude of single-frequency signals, by which the distribution of input signals over the frequency spectrum can be changed easily. Therefore, the three-dimensionality of the input images can be much improved.

To achieve above object, the present invention provides a A method for enhancing three-dimensionality of electronic images and device of the same, comprising: a multi-channel signal filtering module for receiving input image signals and then decomposing said signals into a multitude of single-mode signals; a signal analyzing unit coupled with said multi-channel signal filtering module for analyzing said single-mode signals and for determining a frequency distribution spectrum; a frequency-distribution adjustment/signal amplifying unit coupled with said signal analyzing unit for redistributing relative amplitudes of signals of various frequencies in accordance with a predetermined transfer function; and a signal mixing unit coupled with said frequency-distribution adjustment/signal amplifying unit for combining said readjusted single-mode signals to form output image signals.

The various objects and advantages of the present invention will be more readily understood from the following detailed description when read in conjunction with the appended drawings.

### BRIEF DESCRIPTION OF THE DRAWINGS

FIG. 1 is a circuit block diagram of the present invention.

FIG. 2A is a frequency spectrum before adjustment.

FIG. 2B is a frequency spectrum after adjustment.

FIG. 3 is a flow chart of the dynamic signal adjustment and redistribution.

### DETAILED OF THE PREFERRED EMBODIMENTS

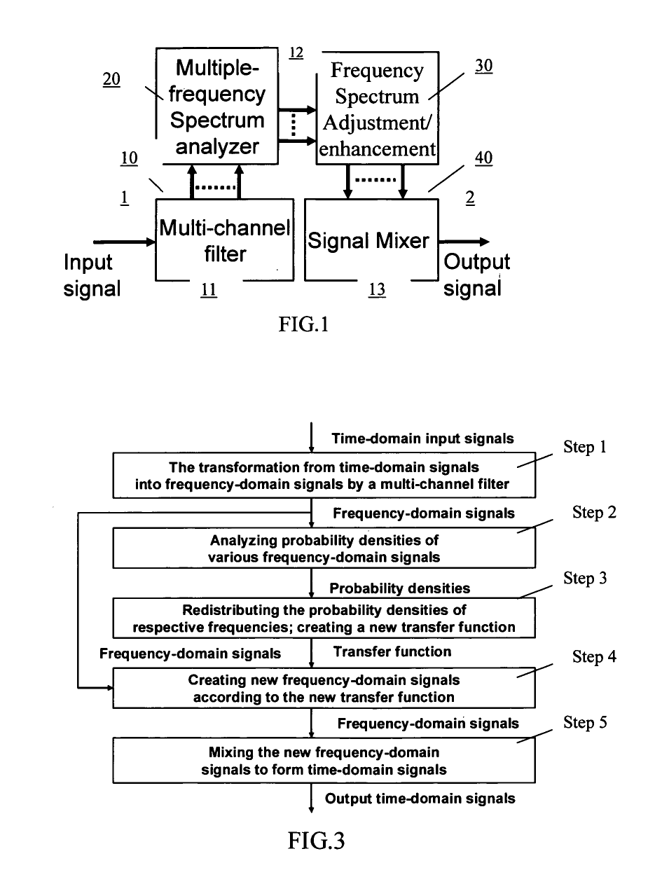

Referring to FIG. 1, a method for enhancing three-dimensionality of electronic images and a device of the same comprises a multi-channel signal filtering module 10 for receiving input video signals and then decomposing each of the images into a multitude of single-mode signals, a signal analyzing unit 20 coupled with the multi-channel signal filtering module 10 for analyzing the single-mode signals and for determining a frequency distribution spectrum, a frequency-distribution adjustment/signal amplifying unit 30 coupled with the signal analyzing unit 20 for redistributing relative amplitudes of signals of various frequencies in accordance with a predetermined transformation model, and a signal mixing unit 40 coupled with the frequency-distribution adjustment/signal amplifying unit 30 for combining the readjusted single-mode signals to form output video signals. The input signal 1 can be a video signal selected from a composite video signal, a signal from a color differentiation terminal, an S-video signal and one of other Y/C digital signals.

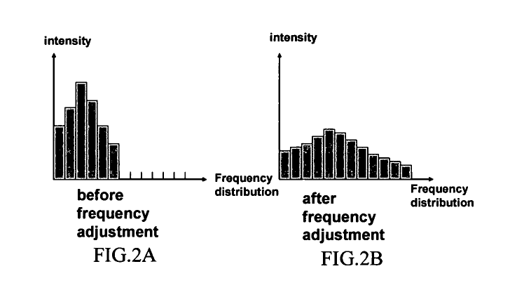

The multi-channel signal filtering module 10 accepts a video signal, which can be a composite video signal or a signal from a color differentiation terminal, an S-video signal or one of other Y/C digital signals. The input signal 1 is then decomposed into a multitude single-frequency signals 11 of high and low frequencies. Therefore, the time-domain signal is converted to frequency-domain signal, which can be used for subsequent frequency spectrum analysis. The signal analyzing unit 20 connected to multi-channel signal filtering module 10 processes the various modes of the frequency domain signal and then determines the frequency distribution 12, as shown in FIG. 2A. Of course, the frequency spectrum of the original time-domain signal is not uniform.

The frequency-distribution adjustment/signal amplifying unit 30 is connected to the output terminal of the signal analyzing unit 20, whereby the frequency distribution 12 produced in the signal analyzing unit 20 is adjusted so that the three-dimensionality of the video signal is enhanced according to a Fourier equation (transfer function). A new frequency-domain signal 13 with modified frequency distribution is then produced, as shown in FIG. 2B. The adjustment is dynamic and performed continuously.

The signal mixing unit 40 is connected to the output terminal of the frequency-distribution adjustment/signal amplifying unit 30 for receiving the new frequency-domain signal 13 and combining various frequency modes into a composite output video signal 2. The output video signal 2 passes through a variety of polarity gates and linear data drivers to form video images that appear more three-dimensional.

Refereeing to FIG. 3, the method of the present invention comprises the steps as follow.

(1) using a multi-channel signal filter to decompose an input signal into a multitude of single-frequency signals;

(2) determining the frequency distribution of the frequency-domain signal amplitudes by signal analyzing unit;

(3) analyzing the relative amplitudes of the frequency-domain signal and creating a new transfer function is produced;

(4) dynamically enhancing and adjusting a spectrum of the single-mode signals according to the new transfer function; and

(5) mixing said adjusted single-mode signals by a signal mixing unit for producing an output video signal.

### Thereby, the three-dimensionality of the modified output video signal is enhanced.

To summarize, the present invention utilizes the following steps to enhance the three-dimensionality of an input video image, which are using a multi-channel signal filter to decompose an input signal into a multitude of single-mode signals, dynamically enhancing and adjusting a spectrum of the single-mode signals, and mixing the adjusted single-mode signals by a signal mixing unit for producing an output video signal.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for enhancing three-dimensionality of electronic images and device of the same, comprising:
a multi-channel signal filtering module for receiving input image signals and then decomposing said signals into a multitude of single-mode signals;
a signal analyzing unit coupled with said multi-channel signal filtering module for analyzing said single-mode signals and for determining a frequency distribution spectrum;
a frequency-distribution adjustment/signal amplifying unit coupled with said signal analyzing unit for redistributing relative amplitudes of signals of various frequencies in accordance with a predetermined transfer function; and
a signal mixing unit coupled with said frequency-distribution adjustment/signal amplifying unit for combining said readjusted single-mode signals to form output image signals.

2. The method for enhancing three-dimensionality of electronic images and device of the same of claim 1 wherein said transfer function is a Fourier equation.

3. A method for dynamic signal adjustment especially used in video signal processing so as to attain better three-dimensionality of an video image by varying a frequency spectrum thereof, comprising the steps of:
(1) using a multi-channel signal filter to decompose an input signal into a multitude of single-mode signals;
(2) dynamically enhancing and adjusting a spectrum of said single-mode signals; and
(3) mixing said adjusted single-mode signals by a signal mixing unit for producing an output video signal.
